(19) United States
(12) Patent Application Publication
(10) Pub. No.: US 2006/0000674 A1
(43) Pub. Date: Jan. 5, 2006

(54) Fall arrest system with anchorage plate

(75) Inventors: Kevin McIntire, Stoneboro, PA (US); Roy B. Bendickson, Sharpsville, PA (US)

Correspondence Address: MCDERMOTT WILL & EMERY LLP, 600 13TH STREET, N.W., WASHINGTON, DC, 20005-3096, US

(73) Assignee: WERNER CO.

(21) Appl. No.: 10/992,705

(22) Filed: Nov. 22, 2004

Related U.S. Application Data
(63) Continuation-in-part of application No. 10/880,347, filed on Jun. 30, 2004.

(51) Int. Cl. E06C 5/32

(52) U.S. Cl. 182/129

(57) ABSTRACT

A ladder includes a pair of opposing side rails and at least one attachment device configured to be attached to a fall arresting device. The opposing side rails have a plurality of steps disposed therebetween along substantially an entire length of the opposing side rails. The attachment device is configured to be attached to a fall arresting device and is substantially centrally disposed between the pair of opposing side rails. The attachment device is a plate, substantially parallel to a plane defined by the opposing side rails, that extends from one of the side rails to the other side rail. The ladder includes a pair of curved members respectively extending from the pair of opposing side rails at an upper distal end of the ladder. One of the attachment devices is positioned substantially centrally along a longitudinal axis of the ladder, and another of the attachment devices is positioned substantially proximate to the upper distal end of the ladder.

### CROSS REFERENCE TO RELATED APPLICATIONS

This application is a Continuation-In-Part of U.S. application Ser. No. 10/880,347, filed on Jun. 30, 2004, incorporated herein by reference in its entirety.

### TECHNICAL FIELD

The disclosure relates generally to ladders, such as those ladders used for “posting” or hanging advertisements on outdoor advertising billboards during which a fall arresting device, such as an arrestor hook or lanyard hook, is used as a safety device.

### BACKGROUND ART

When working with relatively long ladders, such as greater than 10 feet in length, certain work safety rules require the use of a ladder fall arrest system, such as a lifebelt, friction brake, and/or sliding attachments in lieu of cage protection. An example of a type of ladder in which a safety device is required is a posting ladder. Conventional posting ladders 10 typically come in either a straight or tapered form, such as shown in FIGS. 1A-1B, respectively. These ladders 10 are typically hooked over the top of a billboard 20 with hooks 40, and the bottom end of the ladder is permitted to hang freely without vertical support, such as shown in FIG. 1C. In certain instances, the bottom end of the ladder 10 is displaced horizontally from the billboard 20 by a catwalk 30, which projects laterally from the bottom of the billboard 20 generally between about one and four feet.

An example of a conventional fall arrest system used with a posting ladder is disclosed by Bell in U.S. Pat. No. 5,219,039. The fall prevention system includes a waist belt/harness worn by the user that is connected to a lanyard. The lanyard is in turn connected to a safety rope via a sliding connector. The safety rope is stretched across the length of a bill board so that the sliding connector can be slid along the rope across the full width of the billboard. This system, however, must first be installed prior to use and will eventually be removed prior to the need for the safety device has ended. The process of installing and removing this system takes time and does not afford a user protection during the installation and removal process.

Another type of a conventional fall arrest system is illustrated is FIG. 2. This fall arrest system includes an attachment device 16 that is configured to be attached to either the left side rail 12 or right side rail 14 of the ladder 10. The attachment device 16 is also configured to be connected to a hook (or other connection device) of a lanyard, which is connected to the user. A problem with this particular type of fall arrest system is evident during its actual use when a person falls. As the person falls, the lanyard pulls on the attachment device 16, which is on one side rail 12 or the other side rail 14 of the ladder 10. However, since the attachment device 16 is not centered relative to the hooks 40, the force create by the fall is unevenly distributed to the hooks 40. This can cause the ladder 10 to jerk sideways, break the side rail to which the attachment device 16 is attached, and/or break the particular hook 40 receiving the greater force. There is, therefore, a need for a fall arrest system that is not required to be installed or removed and does not have the problems attendant with conventional fall arrest systems.

### SUMMARY OF THE DISCLOSURE

This and other needs are met by the present invention, which in accord with one aspect includes a ladder having a pair of opposing side rails and at least one attachment device configured to be attached to a fall arresting device. The opposing side rails have a plurality of steps disposed therebetween along substantially an entire length of the opposing side rails. The attachment device is configured to be attached to a fall arresting device and is substantially centrally disposed between the pair of opposing side rails.

In another aspect, the attachment device is a plate, substantially parallel to a plane defined by the opposing side rails, that extends from one of the side rails to the other side rail. The ladder may include a pair of curved members respectively extending from the pair of opposing side rails at an upper distal end of the ladder. One of the attachment devices is positioned substantially centrally along a longitudinal axis of the ladder, and another of the attachment devices is positioned substantially proximate to the upper distal end of the ladder.

Other aspects and advantages of the present disclosure will become apparent to those skilled in this art from the following description of preferred aspects taken in conjunction with the accompanying drawings. As will be realized, the disclosed concepts are capable of other and different embodiments, and its details are capable of modifications in various obvious respects, all without departing from the spirit thereof. Accordingly, the drawings, disclosed aspects, and description are to be regarded as illustrative in nature, and not as restrictive.

### BRIEF DESCRIPTION OF THE DRAWINGS

The foregoing and other features, aspects and advantages of the present concepts are described in the following detailed description which examples are supplemented by the accompanying drawings, in which:

FIGS. 1A-1C are perspective views of a conventional straight posting ladder, a conventional tapered posting ladder, and a conventional straight posting ladder attached to a billboard;

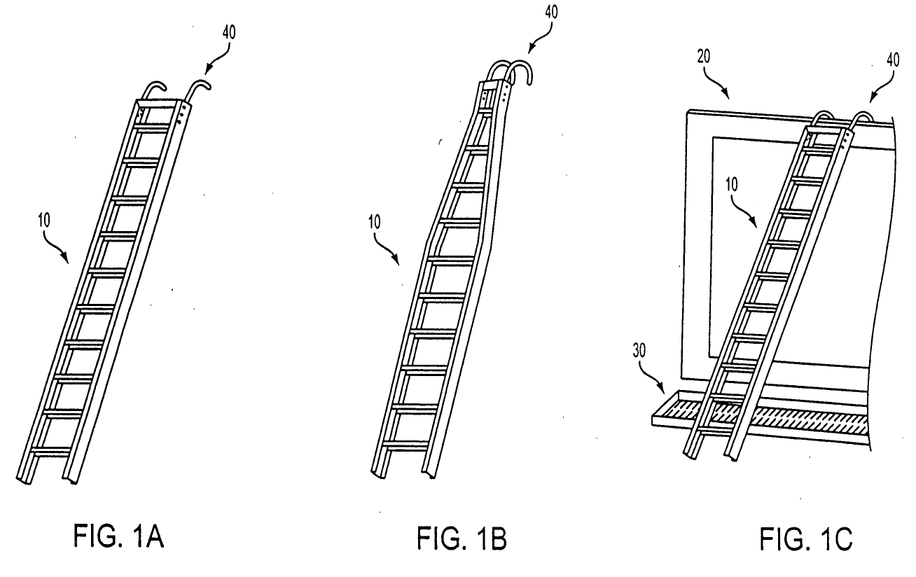

FIG. 2 is a perspective view of a straight posting ladder with a conventional attachment device connected to a side rail of the ladder;

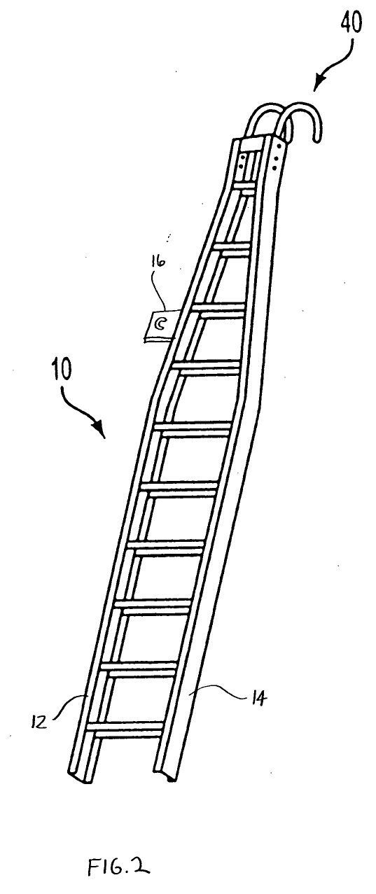

FIG. 3 is a perspective view of a ladder and fall arresting system, according to the disclosure;

FIGS. 4A and 4B are perspective partial views of the ladder and upper fall arrest system shown in FIG. 3; and

FIGS. 5A and 5B are perspective partial views of the ladder and middle fall arrest system shown in FIG. 3.

### DETAILED DESCRIPTION OF THE PREFERRED EMBODIMENTS

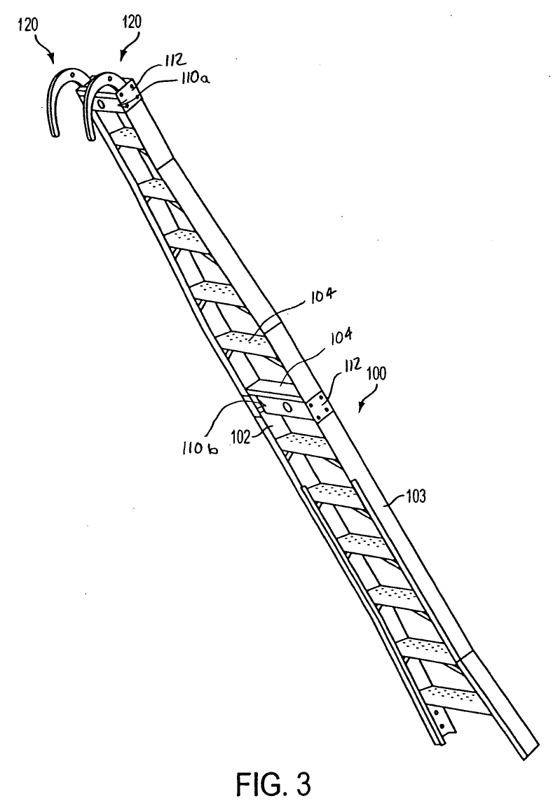

In accord with the disclosed concepts, there is provided, as shown in FIGS. 3, 4A, 4B, and 5A, 5B, a posting ladder 100 including one or more attachment devices 110 configured for attachment to a fall arrest system of a user. The attachment device 110 is not limited in the manner in which the attachment device 110 is configured to attach to the fall arrest system. For example, the attachment device 110 can include a hook or U-bracket to which, for example, a lanyard of the fall arrest system can be attached.

In one aspect of the ladder 100, the attachment device 110 is a plate 106 having a centrally-disposed hole 108. The plate 106 may also completely extend from the right side rail 103 to the left side rail 105. The ladder 100 is not limited as to the orientation or particular location of the plate 106 on the ladder 100. However, in a current aspect, the plate 106 is substantially parallel to a plane defined by the opposing side rails 103, 105. In this manner, the plate 106 may be positioned so as to not substantially protrude from the ladder 100. Otherwise, if the plate 106 protruded from the ladder 100, the plate 106 could catch on objects when the ladder 100 is being positioned or even become an obstacle when the user climbs up and down the ladder 100.

The plate 106 may also be positioned to the rear of the ladder 100. As defined herein, the rear of the ladder 100 is the side opposite to where the user would climb up and down the ladder 100. With a posting ladder 100 that includes hooks 120, the rear of the ladder 100 is in the direction the hooks 120 extend away from the ladder 100. By positioning the plate 106 to the rear of the ladder 100, instances in which the plate 106 interferes with the user can be reduced.

The attachment device 110 is substantially centrally disposed between a pair of opposing (i.e., right and left) side rails 103, 105 of the ladder 100. By positioning the attachment device 110 in this manner, the attachment device 110 transmits forces evenly to both side rails 103, 105, which tends to center the ladder 100 when the fall arrest system exerts a downward force upon the attachment device 110.

The manner in which the attachment device 110 is connected to the ladder 100 is not limited in any particular manner. Although the attachment device 110 may be detachable from the ladder 100, in a current aspect of the ladder 100, the attachment device 110 is permanently attached to the ladder 100. The attachment device 110 is also not limited in manner in which the attachment device 110 permanently connects to the ladder 100. For example, the attachment device 110 may be connected to right and left brackets 112, which are in turn respectively connected to the right and left side rails 103, 105. The attachment device 110 may also be connected to a step 104 of the ladder 100.

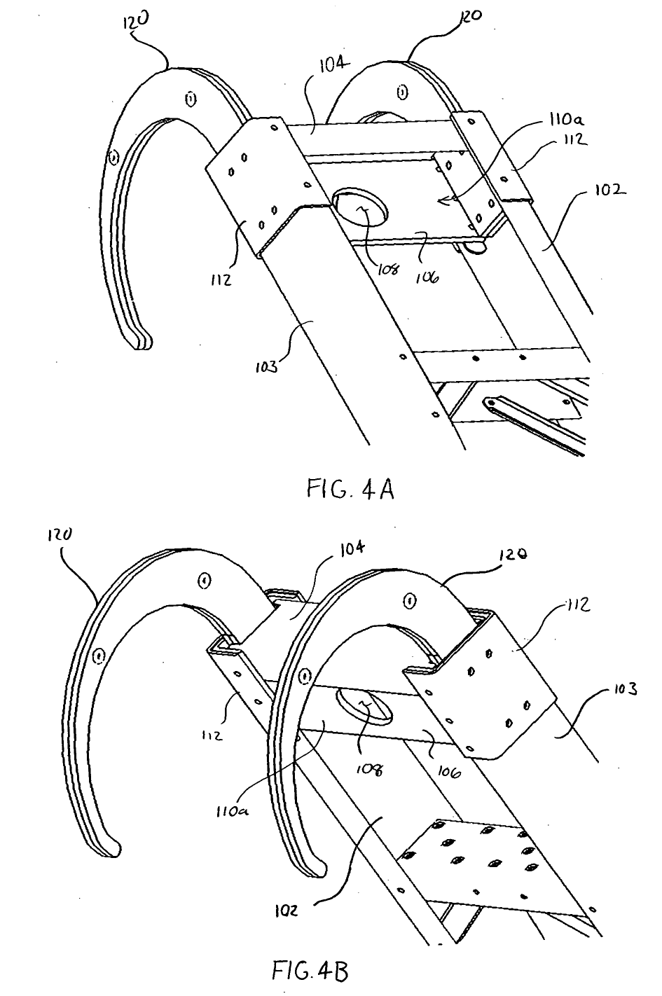

The ladder 100 is also not limited as to the number and locations of attachment devices 100. For example, one attachment device 110 or multiple attachment devices 110a, 110b may be provided on the ladder 100. If a single attachment device 110 is provided on the ladder 100, the attachment device 110, for example, may be located at an upper distal end of the ladder as shown in FIGS. 4A, 4B. By positioning the attachment device 110 at the upper-most portion of the ladder 100, a user connected to the attachment device 110 would always be positioned substantially at or below the position of the attachment device 110, which decreases the distance the user would fall before the fall arrest system is activated.

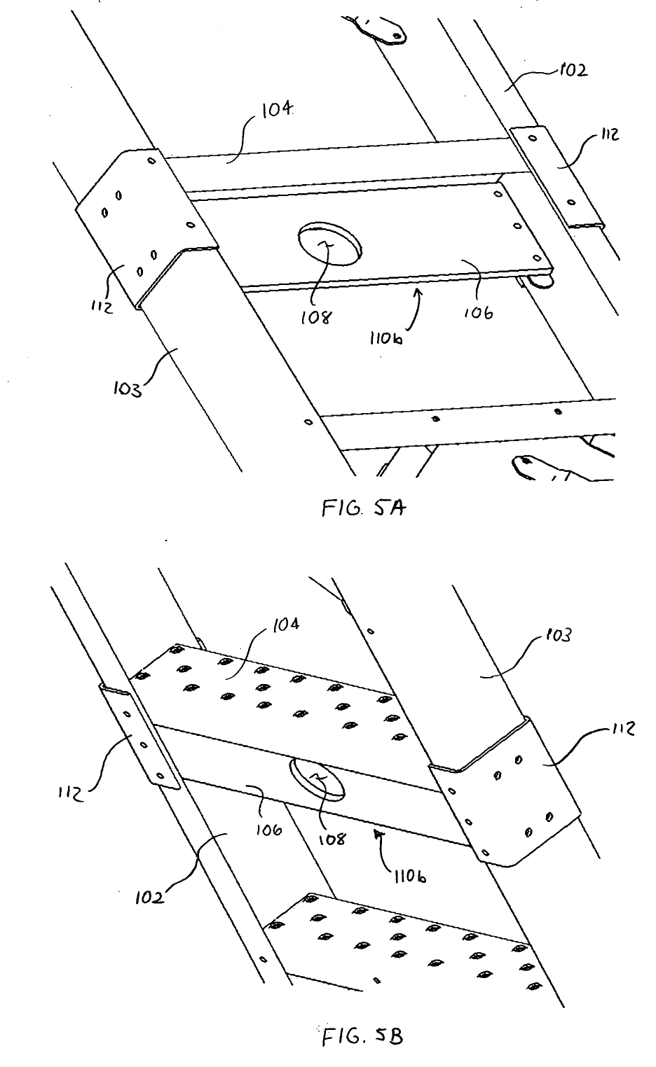

If, for example, multiple attachment devices 110 are provided on the ladder, one attachment device 110 may be positioned at the upper-most portion of the ladder 100, and a second attachment device 110 may be positioned substantially centrally along a longitudinal axis of the ladder, as shown in FIGS. 3 and 5A, 5B. By positioning the attachment devices 110, each attachment device 110 will cover substantially the same length of ladder 100. Alternatively, the attachment devices 110 may be located on the ladder 100 at predetermined distances. For example, for a 15′ ladder and three attachment devices 110, the attachment devices 110 may be located every 5′ along the ladder 100. The predetermined distance the attachment devices 110 are located along the ladder 100 may also be determined by the type of fall arrest system used. For example, if the fall arrest system uses a lanyard, the predetermined distance may increase with longer lanyards and decrease with shorter lanyards.

As with other types of ladders, which may also advantageously utilize the hooks 120 disclosed herein, the ladder 100 is typically formed from aluminum, fiberglass, or pultruded or extruded resinous (e.g., thermosetting or thermoplastic) materials. In various aspects, the overall length of the ladder 100, as measured by the ladder rails 102, 103, is advantageously selected to be between 13′ and 22′, with 14′ and 16′ being preferred lengths and lengths of 18′ and 20′ also being desirable. The present ladder 100, however, is not limited to a particular length.

As with conventional tapered posting ladders 10, the upper portion of ladder 100 may be inwardly tapered (best shown in FIG. 3). This tapering may occur at the upper 5′ feet of the ladder 100 length or at any other arbitrary point. The degree of the taper may be changed depending upon the starting point of the inward taper along the length of the ladder 100 to provide a ladder step of suitable width at the upper extents of the ladder 100. Additionally, an outward taper may be provided at a bottom portion of the ladder 100. Again, the outward taper may occur at the lower 5′ feet of the ladder length, or at any other arbitrary point, with the degree of the taper selected so as to provide a manageable ladder width and to ensure stability of the base of the ladder 100.

The embodiments described herein can be practiced by employing conventional materials, methodology and equipment. Accordingly, the details of such materials, equipment and methodology are not set forth herein in detail. In the previous descriptions, numerous specific details of one preferred example, such as specific materials, structures, etc., are set forth to provide a grounding in the present invention. However, it should be recognized that the present invention can be practiced without resorting to the details specifically set forth. In other instances, well known processing structures have not been described in detail, in order not to unnecessarily obscure the present invention. It is to be understood that the present invention is capable of use in various other combinations and environments and is capable of changes or modifications within the scope of the inventive concept as expressed herein.

What is claimed is:

1. A ladder, comprising:
a pair of opposing side rails having a plurality of steps disposed therebetween along substantially an entire length of the opposing side rails; and
at least one attachment device configured to be attached to a fall arresting device, wherein the attachment device is substantially centrally disposed between the pair of opposing side rails.

2. The ladder according to claim 1, wherein one of the at least one attachment device includes a plate extending from the one of the pair of side rails to the other of the pair of side rails.

3. The ladder according to claim 2, wherein the attachment device defines a hole.

4. The ladder according to claim 2, wherein the plate attaches to each of the pair of opposing side rails.

5. The ladder according to claim 2, wherein the plate is substantially parallel to a plane defined by the opposing side rails.

6. The ladder according to claim 1, wherein one of the least one attachment device is positioned substantially proximate to an upper distal end of the side rails.

7. The ladder according to claim 6, further comprising a pair of curved members respectively extending from the pair of opposing side rails at the upper distal end.

8. The ladder according to claim 1, wherein one of the at least one attachment device is positioned substantially centrally along a longitudinal axis of the ladder.

9. The ladder according to claim 1, wherein a first of the least one attachment device is positioned substantially proximate to an upper distal end of the side rails and a second of the at least one attachment device is positioned substantially centrally along a longitudinal axis of the ladder.

10. The ladder according to claim 1, wherein one of the at least one attachment device is attached to one of the plurality of steps.

11. A hooked ladder, comprising:
a pair of opposing side rails having a plurality of steps disposed therebetween along substantially an entire length of the opposing side rails;
a curved member connected to a top end of each of the side rails to extend in a common direction substantially perpendicular to the side rails; and
at least one attachment device configured to be attached to a fall arresting device, wherein the attachment device is substantially centrally disposed between the pair of opposing side rails.

12. The hooked ladder according to claim 11, wherein one of the at least one attachment device includes a plate extending from the one of the pair of side rails to the other of the pair of side rails.

13. The hooked ladder according to claim 12, wherein the attachment device defines a hole.

14. The hooked ladder according to claim 12, wherein the plate attaches to each of the pair of opposing side rails.

15. The hooked ladder according to claim 12, wherein the plate is substantially parallel to a plane defined by the opposing side rails.

16. The hooked ladder according to claim 11, wherein one of the least one attachment device is positioned substantially proximate to an upper distal end of the side rails.

17. The hooked ladder according to claim 16, wherein the curved members respectively extend from the pair of opposing side rails at the upper distal end.

18. The hooked ladder according to claim 11, wherein one of the at least one attachment device is positioned substantially centrally along a longitudinal axis of the ladder.

19. The hooked ladder according to claim 11, wherein a first of the least one attachment device is positioned substantially proximate to an upper distal end of the side rails and a second of the at least one attachment device is positioned substantially centrally along a longitudinal axis of the ladder.

20. The hooked ladder according to claim 11, wherein one of the at least one attachment device is attached to one of the plurality of steps.
